(19) United States
(12) Patent Application Publication
(10) Pub. No.: US 2016/0290608 A1
(43) Pub. Date: Oct. 6, 2016

(54) LIGHT SOURCE DEVICE

(71) Applicant: USHIO DENKI KABUSHIKI KAISHA, Tokyo (JP)

(72) Inventors: Akinori OHASHI, Tokyo (JP); Yoshihiro KANAHASHI, Tokyo (JP); Yoshihisa YOKOKAWA, Tokyo (JP)

(73) Assignee: USHIO DENKI KABUSHIKI KAISHA, Tokyo (JP)

(21) Appl. No.: 15/037,428

(22) PCT Filed: Nov. 18, 2014
(86) PCT No.: PCT/JP2014/080499

§ 371 Date: May 18, 2016

(30) Foreign Application Priority Data
Nov. 22, 2013 (JP) 2013-241756

(51) Int. Cl. F21V 19/00; F21V 29/67; F21V 29/76

(52) U.S. Cl. CPC F21V 19/003; F21V 29/76; F21V 29/673; F21Y 2101/02

(57) ABSTRACT

A light source device includes a casing, and a plurality of light source units arranged side by side in the casing. Each of the light source units has a heatsink, a light emitting element substrate attached to the heatsink, light emitting elements mounted on the substrate. The light source device also includes a plurality of cooling fans such that they face cooling fins of the heatsinks. The light source units are arranged side by side in a direction orthogonal to the extending direction of the cooling fins of the heatsinks, the cooling fans are arranged side by side in the same direction as the arrangement direction of the light source units, and a partition plate that extends substantially parallel to the extending direction of the cooling fins and toward the cooling fins is disposed between each two adjacent cooling fans.

### TECHNICAL FIELD

The present invention relates to a light source device, and particularly to a light source device that has a plurality of light source units, each of which has a plurality of light emitting elements mounted on a substrate.

### BACKGROUND ART

Conventionally, a light source that emits ultraviolet beams is often used as a light source in a printing industry and an electronic industry in order to perform a hardening process, a curing process, a drying process, a melting process, a softening process and/or a reforming process to an object to be treated such as a protection film, an adhesive agent, painting, an ink, a photoresist, resin, an oriented film and the like. In recent years, an LED element is utilized as a light source element to emit light in an ultraviolet range. A light source device that includes such ultraviolet light source units having light emitting elements (LED elements) to emit light in the ultraviolet range is also developed.

An arrangement that includes a light source device having the LED elements together with an ink jet head of an ink jet printer is disclosed in Japanese Patent Application Laid-Open Publication No. 2004-358769 (Patent Literature Document 1).

In a light source unit that has a plurality of LED elements, the temperature of the LED elements rises because the LED elements generate heat during operation. As the temperature of the LED elements rises, a luminous efficacy drops and an optical output decreases. Thus, the light source unit is equipped with a cooling mechanism at a particular part of the light source unit.

There are various types of cooling mechanism. For example, Japanese Patent Application Laid-Open Publication No. 2011-529627 (Patent Literature Document 2) discloses a cooling mechanism that includes a cooling fan and a heatsink having cooling fins such that the cooling fan faces the heatsink.

A plurality of light source units may be arranged in a single direction side by side in order to increase an area to be irradiated with ultraviolet beams. When a plurality of light source units are arranged and used, a plurality of cooling fans must be arranged side by side along the arranging direction of the light source units.

FIGS. 6(A) and 6(B) of the accompanying drawings show a schematic structure thereof.

As shown in FIG. 6(B), a light source device includes a casing 30, a plurality of light source units 10 and 10 arranged side by side in the casing 30, and a plurality of axial cooling fans 20 and 20. The cooling fans 20 and 20 face the light source units 10 and 10, respectively.

Each of the light source units 10 has a light emitting element substrate 12, a plurality of light emitting elements (LED elements) 11 and 11 mounted on a front surface of the light emitting element substrate 12, and a heatsink 13 attached to the light emitting element substrate 12. A plurality of cooling fins 14 and 14 stand from a back surface of the heatsink 13. The cooling fans 20 face the cooling fins 14 such that the cooling fans 20 send cooling wind to the cooling fins 14.

As shown in FIG. 6(A), however, this configuration causes the cooling wind from adjacent cooling fans 20 and 20 to interfere with each other in an area in front of the cooling fans. Accordingly, the cooling wind does not flow toward the heatsinks in an efficient manner, and a cooling efficiency drops.

As a result, the light source units 10 create different temperature distributions. Also, the LED elements 11 on each substrate 12 of each light source unit 10 have different temperature distributions. This results in a problem, i.e., a luminous intensity distribution is deteriorated.

### LISTING OF REFERENCES

### Patent Literature Documents

PATENT LITERATURE DOCUMENT 1: Japanese Patent Application Laid-Open Publication No. 2004-358769

PATENT LITERATURE DOCUMENT 2: Japanese Patent Application Laid-Open Publication No. 2011-529627

### SUMMARY OF THE INVENTION

### Problems to be Solved by the Invention

The present invention is developed in view of the above-described problems of the conventional technologies, and intends to provide a light source device that includes a casing, a plurality of light source units arranged side by side in the casing, and a plurality of cooling fans arranged in the casing. Each of the light source units has a heatsink, a light emitting element substrate attached to the heatsink, light emitting elements mounted on the light emitting element substrate. The cooling fans are disposed so as to face cooling fins of the heatsinks. The light source device is configured such that cooling wind from adjacent cooling fans does not interfere with each other, and efficiently flows to the cooling fins of the light source units located ahead of the cooling fans, thereby improving a luminous intensity distribution of a group of light emitting elements.

### Solution to the Problems

In order to overcome the above-described problems, the light source device according to one aspect of the present invention is characterized in that the light source units are arranged side by side in a direction orthogonal to the extending direction of the cooling fins of the heatsinks, the cooling fans are arranged side by side in the same direction as the arrangement direction of the light source units, and a partition plate that extends substantially parallel to the extending direction of the cooling fins and toward the cooling fins is disposed between each two adjacent cooling fans.

The partition plate may extend toward an interface between particular two adjacent light source units.

The cooling fins of the heatsink may have a dense part where the cooling fins are arranged at short intervals and a less dense part (coarse part) where the cooling fins are arranged at longer intervals. The less dense part may be formed in a center area of the heatsink when viewed in the arranging direction of the cooling fins.

Between each cooling fan and an associated subgroup of heatsinks, there may be provided a wind guiding plate that extends in a direction perpendicular to the extending direction of the cooling fins. The wind guiding plate may have an inclined surface (tapered surface), which is inclined toward the cooling fins of the subgroup of heatsinks from the cooling fan. The inclined surface may be directed to one end of the cooling fins in the extending direction of the cooling fins.

### Advantageous Effects of the Invention

The light source device according to one aspect of the present invention has the partition plate that prevents the cooling wind from the adjacent cooling fans from interfering with each other, and ensures that the cooling wind efficiently flows to the cooling fins of the respective light source units. This achieves effective and uniform cooling to the light emitting elements. Thus, the luminous intensity distribution of the light emitted from the light emitting elements improves.

When the partition plate extends toward an interface between two adjacent light source units, the light emitting elements in each light source unit are cooled uniformly, i.e., the light emitting elements in each light source unit receive an equal cooling effect.

When the cooling fins in each light source unit have the dense part and the less dense part, and the intervals of the cooling fins is larger in the center area of each light source unit (i.e., the less dense part is formed in the center area), then the contact between the cooling wind and the cooling fins is facilitated in the center area where the temperature becomes the highest. Thus, the cooling effect increases in the center area of each light source unit.

When the wind guiding plate is provided between each cooling fan and the associated subgroup of heatsinks, the wind guiding plate extends in a direction perpendicular to the extending direction of the cooling fins, the wind guiding plate has the surface inclined toward the cooling fins of the heatsinks from the cooling fan, and the inclined surface is directed to one end of the extending direction of the cooling fins, then the cooling wind from the cooling fan is guided to one ends of the respective cooling fins in the extending direction of the cooling fins, and is caused to flow to the other ends of the respective cooling fins along the entire length of the cooling fins in the extending direction of the cooling fins. This enhances the cooling effect to the cooling fins.

### BRIEF DESCRIPTION OF THE DRAWINGS

FIG. 1(A) is a lateral cross-sectional view of a light source device according to one embodiment of the present invention; and FIG. 1(B) is a cross-sectional view taken along the line A-A.

FIG. 2 is a lateral cross-sectional view of a light source device according to another embodiment of the present invention.

FIG. 3 shows a lateral cross-sectional view of a light source device according to still another embodiment of the present invention.

FIG. 4(A) is a lateral cross-sectional view of a light source device according to yet another embodiment of the present invention; and FIG. 4(B) is a cross-sectional view taken along the line A-A.

FIG. 5 is a graph depicting advantages of the embodiment of the present invention.

FIG. 6 is a set of views schematically showing a conventional light source device.

### DETAILED DESCRIPTION OF EMBODIMENTS

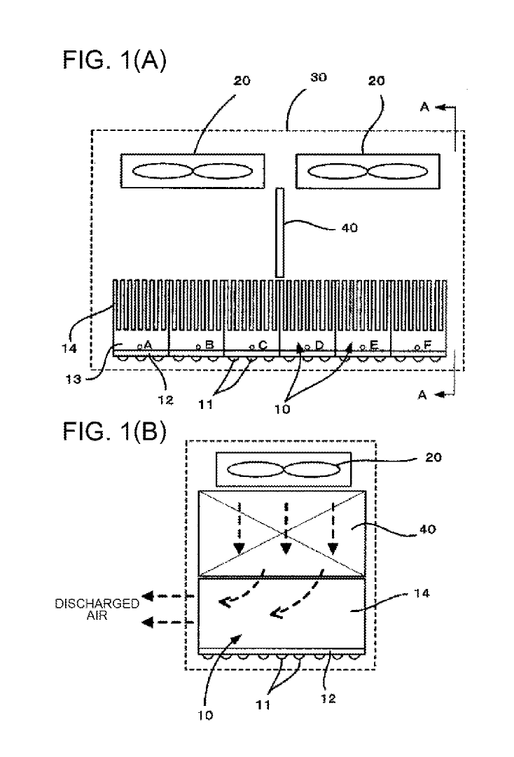

FIGS. 1(A) and 1(B) illustrate an embodiment of the present invention.

In FIG. 1(A), the light source device according to the embodiment of the present invention includes a casing 30, a plurality of light source units 10 in the casing 30, and a plurality of axial cooling fans 20 in the casing 30.

Each of the light source units 10 has a plurality of light emitting elements 11, such as LED elements, a light emitting element substrate 12 on which the light emitting elements 11 are mounted, and a heatsink 13 to which the light emitting element substrate 12 is attached.

The cooling fans 20 face cooling fins 14 of the heatsinks 13 such that the cooling wind from the cooling fans 20 hit the cooling fins 14 to cool the cooling fins 14.

The light source units 10 and 10 are arranged side by side in a direction perpendicular to an extending direction of the cooling fins 14 of the heatsinks 13. The cooling fans 20 and 20 are arranged side by side in the same direction as the arranging direction of the light source units 10. Between the two adjacent cooling fans 20, there is provided a partition plate 40 that extends substantially parallel to the extending direction of the cooling fins 14. The partition plate 40 also extends toward the cooling fins 14.

By having such arrangement, as shown in FIG. 1(B), the partition plate 40 prevents the cooling wind from one cooling fan 20 from interfering with the cooling wind from an adjacent cooling fan 20, and causes the cooling wind to flow toward the cooling fins 14 and flow along the extending direction of the cooling fins 14. Thus, the cooling wind cools the cooling fins 14 and exits from the downstream end of the cooling fins 14.

It should be noted that the three light source units 10 are associated with each cooling fan 20 in this embodiment, but how many light source units 10 should be associated with each cooling fan 20 may be decided on the basis of, for example, the size of the light source unit 10 and the size of the cooling fan 20.

Preferably, the partition plate 40 is disposed such that the partition plate 40 faces an interface between two adjacent light source units 10 and 10. This prevents a single light source unit 10 from being cooled by the cooling wind from the two cooling fans 20. This ensures stable and uniform cooling.

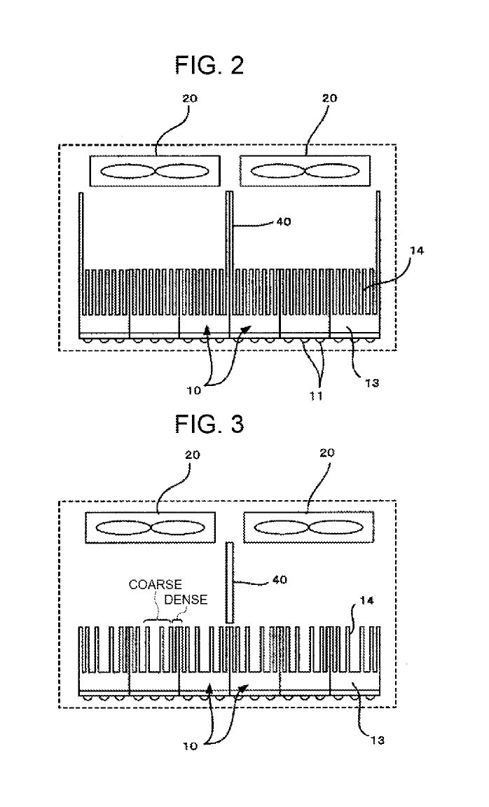

FIG. 2 shows another embodiment of the present invention. In this embodiment, the partition plate 40 is part of the cooling fins 14. Parts of the cooling fins 14 are elongated to form the partition plate 40.

Specifically, those cooling fins 14 which are positioned at the interface between the two adjacent light source units 10 and 10 are elongated toward the cooling fans 20 to form the combined partition plate 40.

FIG. 3 shows still another embodiment of the present invention. In this embodiment, the cooling fins 14 have a dense part and a coarse (less dense) part on each heatsink 13. The cooling fins 14 are arranged at larger intervals in a center area (coarse area) when viewed in the arranging direction of the cooling fins 14.

When the heatsink is made from a common material, i.e., aluminum, a plurality of plate-like cooling fins are arranged at small intervals. As the number of the fins increases, an effective surface area that contacts the ambient air increases, and therefore the cooling efficiency correspondingly improves in theory. As the fins are arranged at small intervals, the thickness of the respective fins decreases, and the effective area increases. However, the heat is not transferred to the entire fins even though aluminum has a high thermal conductivity.

In addition, the cooling wind is difficult to flow in the small gaps between the fins. Thus, the cooling efficiency may drop despite the increased effective area.

To cope with this, only those fins which are located in the center area when viewed in the arranging direction of the fins, where the high temperature heat is generated, are arranged at larger intervals such that an amount of the cooling water that hits the fins increases. Thus, the cooling efficiency improves.

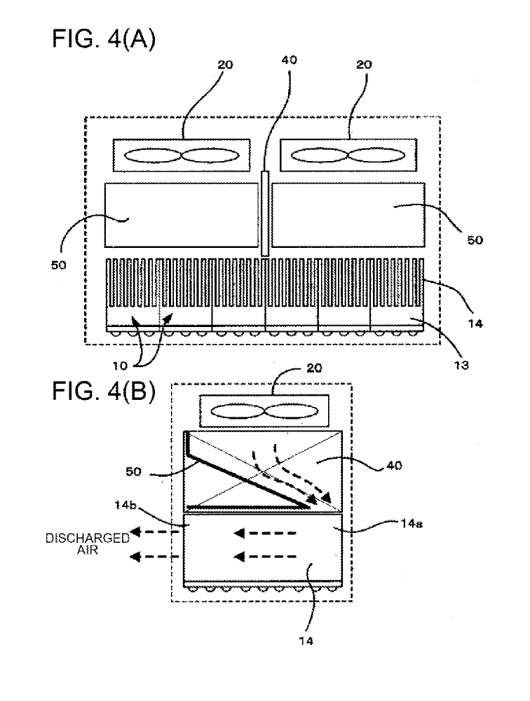

FIGS. 4(A) and 4(B) show yet another embodiment of the present invention. In this embodiment, wind guiding plates 50 are provided between the cooling fans 20 and the heatsinks 13.

As illustrated in FIG. 4(B), each of the wind guiding plates 50 generally extends in a direction perpendicular to the extending direction of the cooling fins 14, and has a tapered portion that inclines from the cooling fan 20 toward one ends 14a of the cooling fins 14 when viewed in the extending direction of the cooling fins 14. Thus, it is possible to guide the cooling wind from the associated cooling fan 20 toward the one sides 14a of the cooling fins 14. It is also possible to cause the cooling wind to flow up to the other ends (sides) 14b of the cooling fins 14 along the entire extending direction of the cooling fins 14. Accordingly, the cooling efficiency of the cooling wind increases.

### Experiments

Experiments were carried out with the light source device shown in FIG. 1 that had the partition plate (embodiment of the present invention) and another light source device that had no partition plate (conventional light source device), and the temperature of the light emitting element substrate was measured. The measuring points are points A-F in FIG. 1(A).

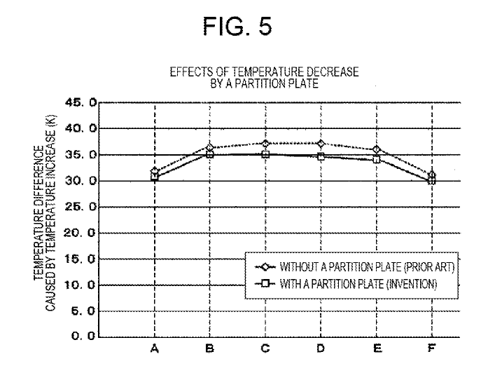

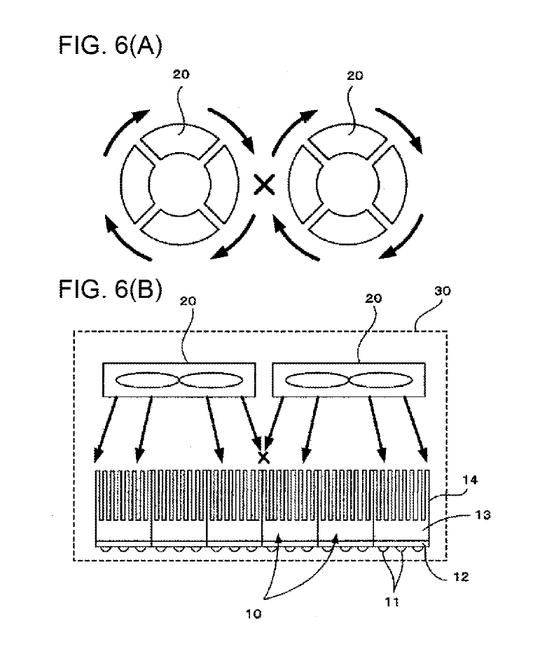

The results are shown in FIG. 5. The example of the present invention (□ or square) shows a smaller temperature difference among the light emitting element substrates of the respective light source units, as compared with the conventional device that had no partition plate (diamond).

As described above, each of the light source devices according to the embodiments of the present invention includes a plurality of light source units, each of the light source units has a plurality of light emitting elements, a plurality of cooling fans face the heatsinks of the light source units, a partition plate is disposed between two adjacent cooling fans such that the partition plate extends substantially parallel to the extending direction of the cooling fins of the heatsinks and also extends toward the cooling fins. Therefore, the two streams of cooling wind from the two adjacent cooling fans do not interfere with each other. Thus, the two streams of cooling wind reach the cooling fins efficiently without deteriorating the cooling effect.

Because the wind guiding plates are disposed between the cooling fans and the heatsinks, the cooling wind from each of the cooling fans is introduced to one ends (sides) of the cooling fins. Thus, the cooling wind is caused to flow along the entire length of the cooling fins in the extending direction of the cooling fins. The effective cooling is therefore achieved.

### REFERENCE NUMERALS AND SIGNS

10: Light source unit

11: Light emitting element (LED element)

12: Light emitting element substrate

13: Heatsink

14: Cooling fins

20: Cooling (axial) fan

30: Casing

40: Partition plate

50: Wind guiding plate

1. A light source device comprising:
a casing;
a plurality of light source units arranged side by side and adjacent to each other in the casing, each of the plurality of light source units having a heatsink, a light emitting element substrate attached to the heatsink, and light emitting elements mounted on the light emitting element substrate;
a plurality of cooling axial fans arranged in the casing such that each of the plurality of cooling axial fans is associated with a subgroup of the plurality of light source units and each of the plurality of cooling axial fans faces cooling fins of a subgroup of the heatsinks, the plurality of light source units being arranged side by side in a first direction, which is perpendicular to an extending direction of the cooling fins of the heatsinks, the plurality of cooling axial fans being arranged side by side in the same direction as said first direction of the plurality of light source units; and
a partition plate disposed between each two adjacent cooling axial fans of the plurality of cooling axial fans, the partition plate extending substantially parallel to the extending direction of the cooling fins and also extending toward the cooling fins, the partition plate extending toward an interface between two adjacent light source units of the plurality of light source units.

2. (canceled)

3. (canceled)

4. (canceled)

5. The light source device according to claim 1, wherein each said light emitting element is a light emitting diode.

6. The light source device according to claim 1, wherein the partition plate is part of the cooling fins.

7. The light source device according to claim 1, wherein the cooling fins of each said heat sink extend toward the associated cooling axial fan.
